(19) United States
(12) Patent Application Publication
(10) Pub. No.: US 2006/0214465 A1
(43) Pub. Date: Sep. 28, 2006

(54) Remotely controlled automatic vehicle cover

(76) Inventor: Vincent Chau, Markham (CA)

Correspondence Address: Intellectual Property Department;DEWITT ROSS & STEVENS, S.C., Suite 401, Firstar Financial Centre, 8000 Excelsior Drive, Madison, WI, 53717-1914, US

(21) Appl. No.: 11/151,558

(22) Filed: Jun. 9, 2005

(30) Foreign Application Priority Data
Mar. 24, 2005 (CA) 2,502,339

(51) Int. Cl. B60J 7/20

(52) U.S. Cl. 296/136.1

(57) ABSTRACT

The present invention relates to an apparatus for remotely controlling a vehicle cover that extends and retracts the cover automatically. The apparatus for remotely controlling a vehicle cover comprises, a plurality of covers for covering a vehicle, a plurality of wires for guiding the cover to extend and retract from and to a housing, a plurality of reel tables placed on the vehicle to route and secure the wires and the cover; and a control module comprising. The control module comprises at least one motor for extending and retracting the covers by controlling the wires; a means for receiving wireless control signals from a user operated remote control means; and a means for interpreting and implementing the signals.

### FIELD OF THE INVENTION

This application claims priority benefits of Canadian Patent Application Serial Number 2,502,339 filed Mar. 24, 2005.

The present invention relates to an apparatus for remotely controlling a vehicle cover that extends and retracts automatically.

### BACKGROUND OF THE INVENTION

Vehicle is one of the most popular and common methods of transportation today, and is facing to the hash environmental exposures, such as freezing rain, hail, snow, dusts, etc. Even an owner of a vehicle may have a garage at home to park the vehicle inside to protect it from those environmental exposures; it is very difficult to protect the vehicle while parking it outside for shopping, working, etc. In a hash cold weather like snowing and freezing rain, the driver may have to spend much time and effort for clearing the snow or a layer of ice accumulated on the vehicle before driving. If the garage is as mobile as a vehicle, the driver just need to park in the “mobile” garage to avoid such hassle.

There are a number of car covers that have been invented and become available in the market; however, these car covers available in the markets are not as easy to use. Quite often, it is very hard and time consuming to install the cover by one person. It is also just as hard to uninstall the cover as to install it, and so much trouble to fold the cover and put it away. Thus, it is not suitable to use this type of covers for short time and frequent parking.

U.S. Pat. No. 6,012,759 issued Jan. 11, 2000 to Adamek teaches a retractable vehicle cover, trying to address such problems. It comprises a housing enclosure installed on top of a vehicle. The covers and extension cables are retracted inside the housing. There is an urging mechanism inside the housing to retract the covers and cables back. One of the disadvantages is that this implementation is still only half automatic, where the user needs to extend cables and covers manually. To extend the covers properly, it is also required to pull each of the covers evenly so that extension lines on both sides of the cover come out evenly. This is quite difficult to do, however, with one person operating the device. And, further, it is also difficult to retract the cover properly by one person as well even though there is a means for urging the cover to retract back into the housing, since it requires maintaining even retraction on both sides of the cover. Also, because it uses magnet to secure the cover position, with real hash weather like a strong wind, the cover may be blown out and may cause damages to the car and thereby defeats the purpose of having a car cover in the first place.

The present invention solves these problems of the prior arts, by providing an apparatus for remotely controlling a roof top cover that automatically extends and retracts the cover.

### SUMMARY OF THE INVENTION

The present invention teaches an apparatus for remotely controlling a vehicle cover that extends and retracts the cover automatically.

The object of the present invention is to provide a “mobile” garage like solution for protecting a vehicle from hash weather conditions.

According to one aspect of the invention, it provides an apparatus for remotely controlling a vehicle cover comprising: (i) a plurality of covers for covering a vehicle; (ii) plurality of wires for guiding said cover to extend and retract from and to a housing; (iii) a plurality of reel tables placed on said vehicle to guide and secure said wires and said cover; and (iv) a control module comprising: a plurality of motors for extending and retracting said covers by controlling said wires; a means for receiving a control signals from a user remotely and wirelessly; and a means for interpreting and implementing said signals.

According to another aspect of the invention, it provides an optional roof top swiping panel.

### BRIEF DESCRIPTION OF THE DRAWINGS

The invention will now be described in more detail with reference to the accompanying drawings, in which:

FIG. 1 illustrates a perspective image of an embodiment of the present invention installed on top of the roof of a vehicle;

FIG. 2 illustrates a side view of an installation example of the embodiment of the present invention;

FIG. 3 illustrates a partially exploded perspective image of the embodiment of the present invention without an image of a vehicle;

FIG. 4 illustrates partially exploded perspective image of the embodiment of the present invention with hatch doors;

FIG. 5 illustrates a schematic view of the embodiment of the present invention while the cover is extended out from the housing;

FIG. 6 illustrates a schematic view of the embodiment of the present invention while the cover is retracted inside the housing;

FIG. 7 illustrates an exploded top view of the control module of the embodiment of the present invention with motors and gears for controlling guiding wires while extending the cover;

FIG. 8 illustrates an exploded top view of the control module of the embodiment of the present invention with motors and gears for controlling guiding wires while retracting the cover;

FIG. 9 illustrates a perspective view of a housing with a swiping panel;

FIG. 10 illustrates a perspective view of a housing with a swiping panel in standing position;

FIG. 11 illustrates a partially sectioned front view of a swiping panel;

FIG. 12 illustrates a side exploded view of a housing with a swiping panel in resting position;

FIG. 13 illustrates a side exploded view of a housing with a swiping panel in standing position;

FIG. 14 illustrates a side exploded view of a housing showing installation instance of heating elements; and

FIG. 15 illustrates a functional block diagram of the control module of the embodiment of the present invention.

### DETAILED DESCRIPTION OF THE INVENTION

The present invention teaches an apparatus for remotely controlling a vehicle cover, which automatically extends and retracts the cover.

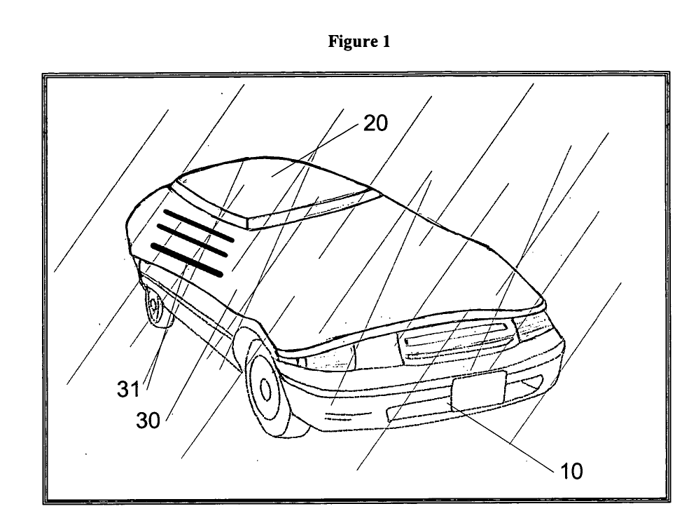

FIG. 1 illustrates an instance of the installation of an embodiment of the present invention. A housing 20 of the vehicle cover apparatus is installed on top of the roof of vehicle 10. The cover 30 is extended out from the housing 20 to cover the vehicle 10. The optional transparent material 31 is used on the cover 30 around the side windows for viewing. Durable and water resistant material may be used for the cover 30. The material of the cover 30 may also be manageably soft to be extended and retracted from and to the housing 20. A woven polyethylene may be used as the cover 30.

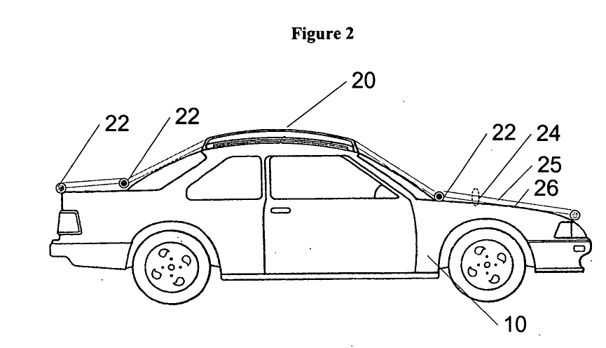

FIG. 2 illustrates a side view of an installation example of this embodiment of the present invention. A housing 20 of the cover 30 (not shown) is installed on top of the roof of vehicle 10. The embodiment consists of a plurality of reel tables 22 mounted securely on the vehicle 10 and a plurality of guiding wires 24 routed around the vehicle 10. Preferably, the guiding wires 24 should not disturb or block the view of a driver of the vehicle 10. The guiding wires 24 may be transparent in color to prevent disturbing the driver's view. The topside 25 of the guiding wire 24 is coming out of the housing 20 and looped at the far end of the reel table 22 back as the bottom side 26 of the guiding wire 24 to the housing 20 for displacing the cover 30 (not shown). These guiding wires 24 are routed through reel tables 22. The cover 30 (not shown) is demoutably and slidably attached to topside 25 of the guiding wire 24 for extending and retracting.

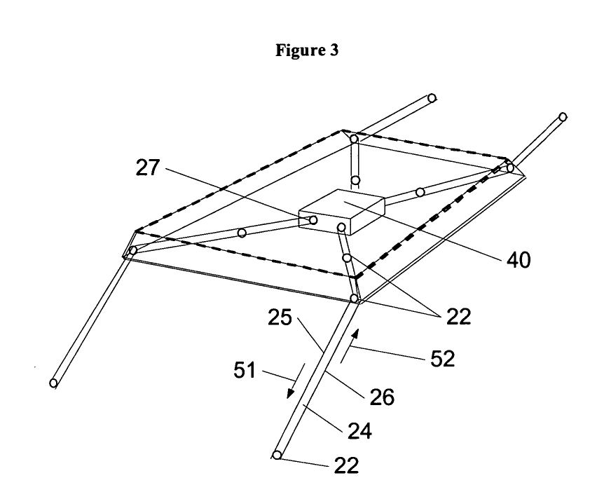

FIG. 3 illustrates a partially exploded perspective image of this embodiment of the present invention without an image of a vehicle 10, where the image of the housing 20 is being transparent in order to display the components inside. Inside the housing 20, there are a control module 40, a plurality of reel tables 22, guiding wires 24, showing topside 25 and bottom side 26 of the guiding wire 24 looped at the far end of the reel table 22. The guiding wires 24 are coming out from the control module 40 through holes 27. The holes 27 are just large enough to prevent any mechanical stress to the guiding wires 24, and are sealed tight to prevent water, dust, ice and snow to enter inside the control module 40. The guiding wires 24 are guided through reel tables 22 inside the housing 20 to manage the cover 30 (not shown) to extend from and retract to the housing 20 properly. The control module 40 comprises a means for operating the guiding wires 24 for the cover 30 (not shown) to extend out from or retract into the housing 20. In order to retract the cover 30 (not shown) back inside the housing 20, the control module 40 causes the topside 25 of the guiding wires 24 to move in an inward direction 52 and the bottom side 26 of the guiding wire 24 to move in an outward direction 51. To extend the cover 30 out from the housing 20, the control module 40 causes the topside 25 of the guiding wires 24 to move in an outward direction 51 and the bottom side 26 of the guiding wires 24 to move in an inward direction 52.

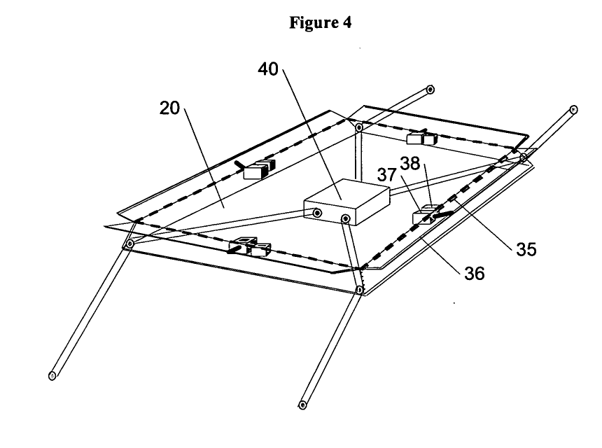

FIG. 4 illustrates a partially exploded perspective image with hatch doors 36 of this embodiment of the present invention without an image of a vehicle 10. The hatch doors 36 are to seal the openings of the housing 20 and to ensure the protection of the cover 30 (not shown) and operable parts and devices inside the housing 20 from the environmental exposures. The hatch doors 36 are mounted along four sides of the housing 20 with hinges 35 to ensure operability. Mechanical devices or conventional means may be utilized for opening and closing the hatch doors 36 automatically. For this purpose, relays 37 can be installed at each side of the housing 20 for operating each of the hatch doors 36. By receiving a command from the remote control, the control module 40 operates the relays 37 for opening and closing of the hatch doors 36. The sensing switches 38 may also be installed along each side of the housing 20, for sensing whether each of the hatch doors 36 is closed properly. In this embodiment of the present invention, the sensing switches 38 are mounted in the middle of each side, beneath the roof of the housing 20; however, the position of the sensing switch 38 respect to the hatch door 36 may be at the bottom, right or left side of the hatch door 36 as long as the sensing switch 38 is able to sense whether the hatch doors 36 are in closing position properly, and do not block or disturb moving or operating devices and parts, including the cover 30, reel tables 22, guiding wires 24, etc. Alternatively, infrared position sensing device may be used, instead, for the same purpose. The sensing switches 38 are connected to the processor 60 (not shown) inside the control module 40, so if any of the hatch doors 36 were not closed properly by sensing through the sensing switch 38, the processor 60 may operate corresponding relays 37 for retry to close the hatch doors 36 accordingly. These hinges 35 may be installed on bottom side of the housing 20. Or, the hatch doors 36 with hinges 35 may be replaced with sliding doors, sliding inside or outside the housing 20; alternatively, flexible and elastic cover may be installed at the opening to replaces the hatch doors 36, or by lifting up/down the roof top of the housing 20 to work as a cover for the same purpose.

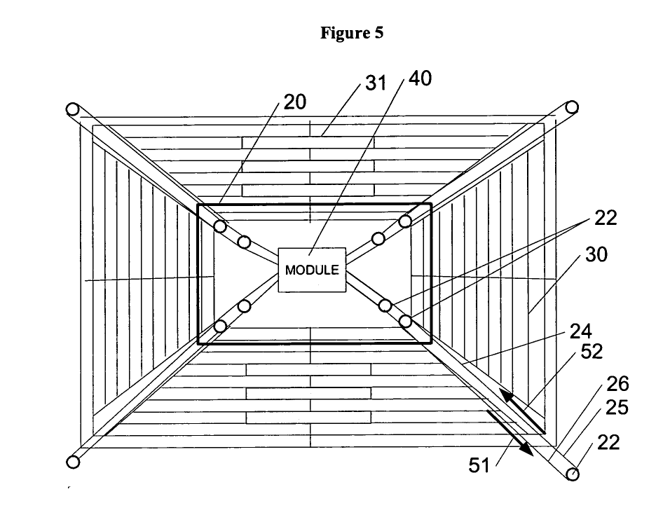

FIG. 5 illustrates a schematic view of this embodiment of the present invention while the cover 30 is extended out from the housing 20. The control module 40 resides inside the housing 20. A plurality of reel tables 22 are placed inside and outside the housing 20 for routing guiding wires 24 to extend and retract the cover 30 properly. To extend out, topside 25 of the guiding wire 24 is moved in an outward direction 51 and the bottom side 26 of the guiding wire 24 is moved in an inward direction 52 from the control module 40 inside the housing 20. Optionally, the transparent material 31 is also used on the cover, which is located around the side windows of the vehicle 10 (not shown).

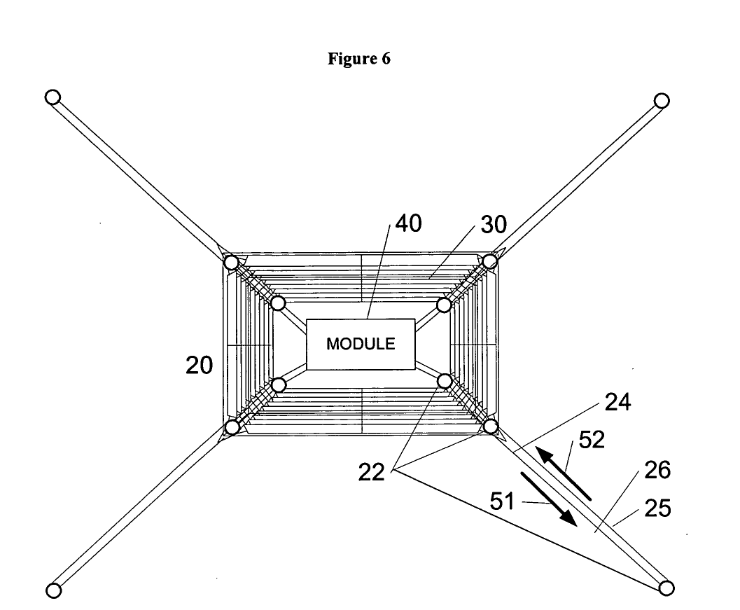

FIG. 6 illustrates a schematic view of this embodiment of the present invention while the cover 30 is retracted inside the housing 20. To retract the cover 30, the control module 40 operates topside 25 of the guiding wire 24 in an inward direction 52 to the housing 20 and bottom side 26 of the guiding wire 24 in an outward direction 51. The cover 30 is folded along the guiding wires 24 routed by the reel tables 22.

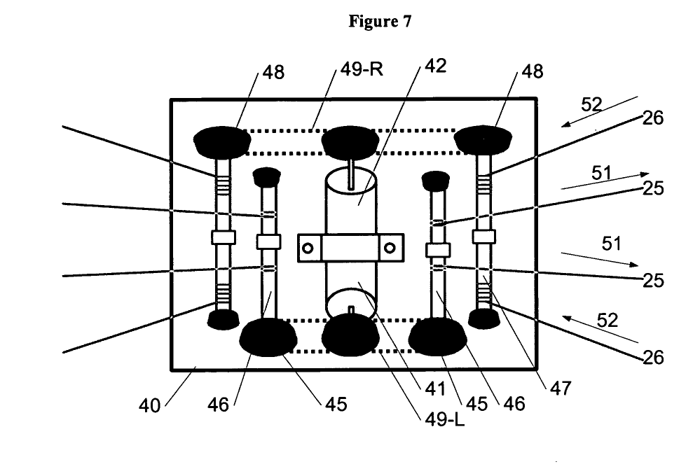

FIG. 7 illustrates an exploded top view of the control module 40 of this embodiment of the present invention with left motor (or L motor) 41, right motor (or R motor) 42, left gears (or L gears) 45, and right gears (or R gears) 48. The L motor drives the chain 49-L to operate the L gears 45. Topsides 25 of the guiding wires 24 are attached to L shaft 46, which is driven by the L motor 41. The R motor 42 drives the chain 49-R to operate the R gears 48. Bottom sides 26 of the guiding wires 24 are attached to R shaft 47, which is driven by the R motor 42. For extending the cover 30, the R motor 42 drives the bottom side 26 of the guiding wire 24 in an inward direction 52 and, as the result, moving the topside 25 of the guide wires 24 in an outward direction 51. While the R motor 42 is running, the L motor 41 is not powered but works as a brake to control the pace of releasing topsides 25 of the guiding wires 24 to match the pace of retracting bottom sides 26 of the guiding wire 24 to make sure sufficient tensions on the guiding wire 24 for proper operation.

Optionally, a single and more powerful motor with different gear configuration may be used to replace these two motors disclosed herein to operate and drive the guiding wires 24 to achieve the same result.

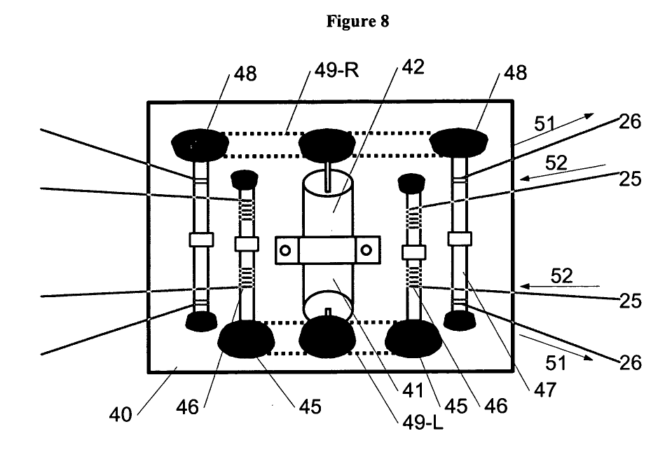

FIG. 8 illustrates an exploded top view of the control module 40 of this embodiment of the present invention with the L motor 41 driving the L gear 45 through the chain 49-L to operate the L shaft 46 for causing topsides 25 of the guiding wires 24 to move in an inward direction 52 to the control module 40, and causing bottom sides 26 of the guiding wires 24 to move in an outward direction 51 from the control module 40 for retracting the cover 30. While the L motor 41 is running, the R motor 42 is not powered but works as a brake to control releasing pace of bottom sides 26 of the guiding wires 24 to match the pace of retracting topside 25 of the guiding wire 24 to make sure sufficient tensions on the guiding wire 24 for proper operation.

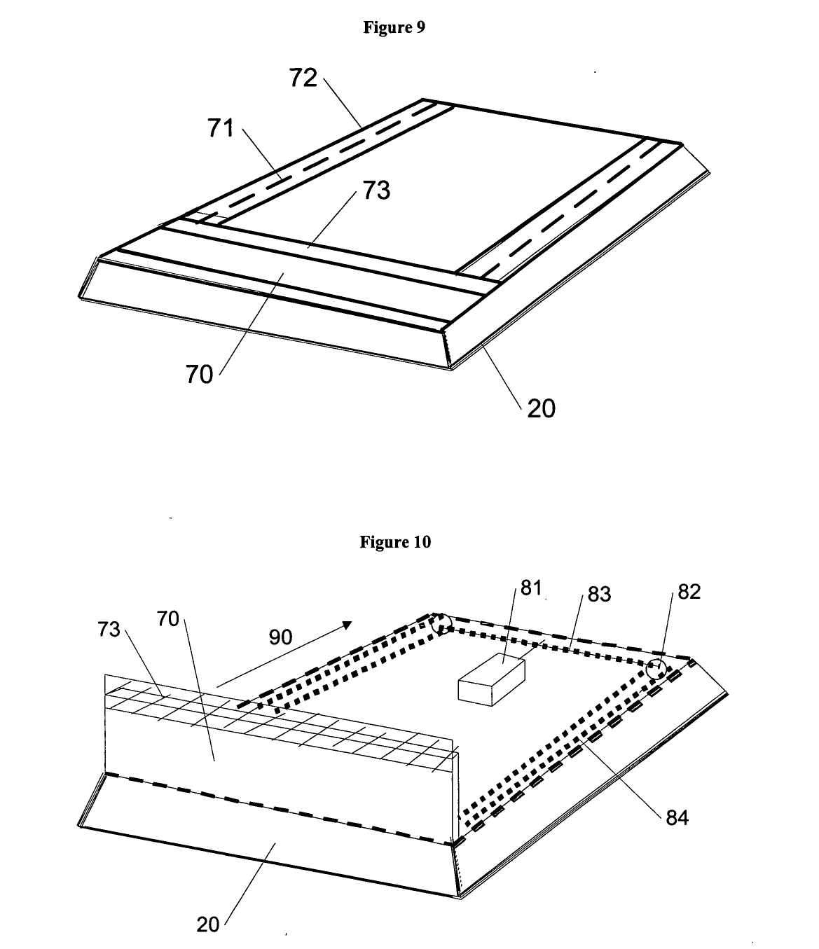

FIG. 9 illustrates a swiping panel 70 installed and integrated on top of the housing 20. Rails 71 are covered by rubber strip 72 for protecting rails 71 from dust, water, ice and snow. A rubber strip 73 is attached on the top of the swiping panel 70 for sealing the gap between the swiping panel 70 and the housing 20. The rubber strip 73 may be mounted on the housing 20. Alternatively, it may be mounted on the swiping panel 70.

FIG. 10 illustrates a perspective view of the swiping panel 70 being raised in standing position on the housing 20. A rubber strip 73 is attached to the top of the swiping panel 70 for sealing gap with the roof top while the swiping panel 70 is in resting position. The motor 81 produces driving force through a shaft 83 for propagating power to the gear tables 82 to drive chains 84, so that the swiping panel 70 move across the roof of the housing 70 along the rails 71 (not shown) in the direction from the front to the back 90.

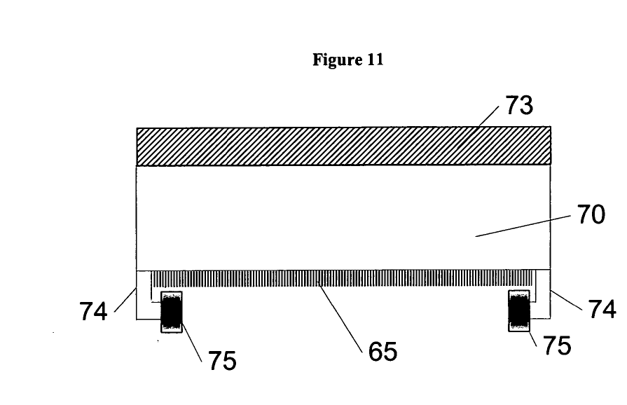

FIG. 11 illustrates a front view of a swiping panel 70, which consists of two gear table rollers 75 on L shaped hooks 74 on the bottom of the swiping panel 70. A rubber strip 73 is attached to the top of the swiping panel 70 for sealing gap with the roof top while the swiping panel 70 is in resting position. The L shaped hooks 74 secure the panel 70 to rails 71 (not shown) for extra strength against any external force. A brush 65 is mounted on bottom of the swiping panel 70 to sweep the roof of the housing 20. Also, there may be small particles that are hard to remove by the force generated by the motor 81 (not shown). In such case, the particles could cause overloading to the motor 81 and extra stress to all the mechanical parts. This brush 65 ensures flexibility and provides sufficient space between the roof top of the housing 20 and the swiping panel 70 to prevent the swiping panel 70 to stack or to ease mechanical stresses to operating device and parts.

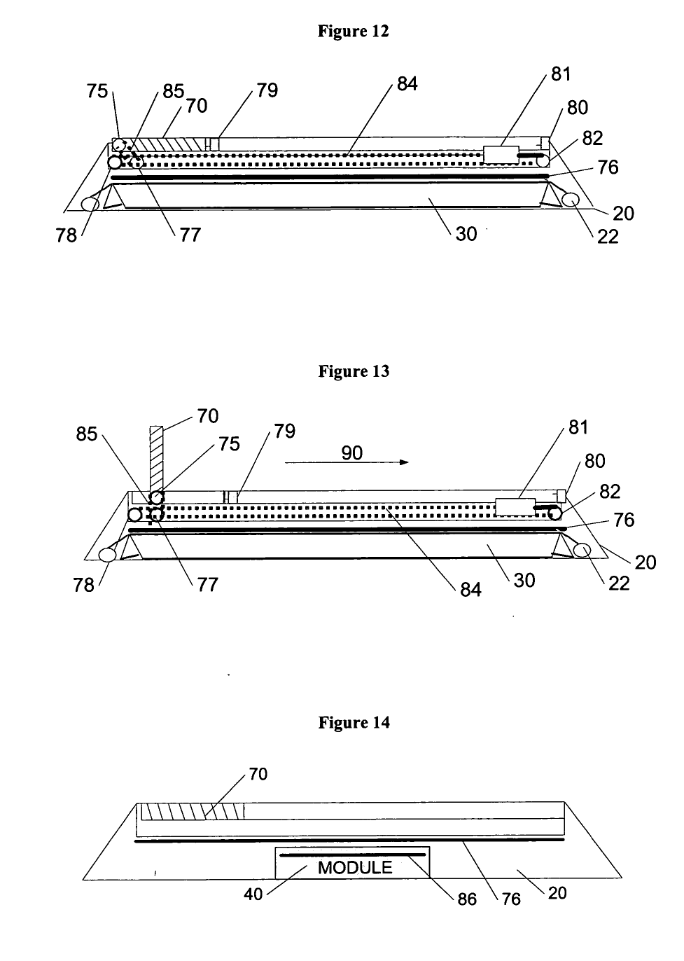

FIG. 12 is a side exploded view of the housing 20 to illustrate the mechanism inside to implement movement of swiping panel 70, while the cover 30 is retracted inside the housing 20. There is a complex mechanical arrangement for implementing such operation. A motor 81 provides driving power for the whole operations. A gear table 82 provides capability to switch manipulating between a gear 77 and a gear 78 through propagating power over a chain 84. The gear 77 interacting with the gear table roller 75 through a chain 85 is used to raise or recline the swiping panel 70. The gear 78 along with the chain 84 is used to move the raised swiping panel 70 to move back and forth along the rail 71 (not shown). The panel switch 79 not only secures the swiping panel 70 from raising by external force, but also works as a sensor to confirm that the swiping panel 70 is in resting position when it reclines from standing position, and cause the motor 81 to stop when the swiping panel 70 is completely in resting position. The switch 79 releases panel 70 when to raise, and secures the swiping panel 70 when reclined in resting position. Another panel switch 80 is installed at the back end of the housing 20. The panel switch 80 works as a sensor, when the swiping panel 70 travels along the rails 71 from the front to the back of the housing, the swiping panel 70 touches the panel switch 80, which causes the motor 81 to reverse the direction of the movement of the swiping panel 70 from the back to the front. The user remotely controls the control module 40 (not shown) to operate the motor 81 and the gear table 82 for swiping top of the housing 20. In order to ensure availability and reliability of the operation, a heat element 76 is installed under top of housing for melting any thick layer of ice or snow. The heat element 76 will melt a thin layer at the contact of the housing 20 so that panel 70 can swipe out the snow or a layer of ice. By the processor 60 (not shown) monitoring temperature using a sensor, the processor 60 may automatically control the heat element 76. Alternatively, the user may remotely activate the heat element 76 by a remote control. The user may also crack layer of ice manually by a scraper to ease the operation.

FIG. 13 illustrates a side exploded view of the housing 20 with the swiping panel 70 in standing position and ready to swipe across the top of the housing 20. The motor 81 through the gear table 82 drives the gear 77 through the chain 84 for interacting with the gear table roller 75 through the chain 85 to lock the panel 70 in standing position. Interacting with the gear 78 and 77, the motor 81 drives the panel 70 in a backward direction 90 from the front to the back of the vehicle 10, so that all snow or ice on top of the housing 20 will be pushed to the back. Once the swiping panel 70 reached and touched to the panel switch 80 on the other end of the housing, the panel switch 80 causes the gear table 82 to reverse the direction of the movement of the swiping panel 70 in forward direction 91 from the back to the front of the vehicle. Alternative to the gear table 82, the panel switch 80 may cause the rotation of motor 81 to reverse to achieve the same result. This reversing process may be mechanically implemented as described herein; alternatively, the control module 40 (not shown) may interact in this process by sensing the swiping panel being reached to the back end of vehicle through the panel switch 80, then the control module 40 causes the gear table 82 to reverse the swiping panel moving direction or causes the motor 81 to reverse the direction.

FIG. 14 illustrates a side exploded view of the housing 20 with heating element 76 for the roof of the housing 20 and heating element 86 installed inside the control module 40 for protecting operating and moving components inside. The heating element 76 is to melt the layer of ice or snow accumulated on the top of roof, in order to ease the swiping panel 70 to sweep out snow or a layer of ice accumulated on the roof top of the housing 20.

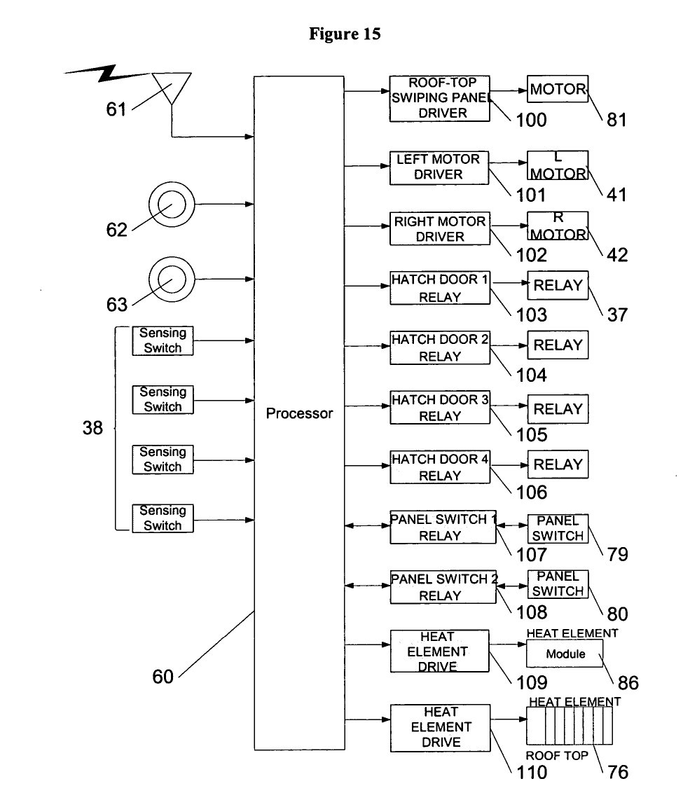

FIG. 15 illustrates a functional block diagram of the control module 40 of this embodiment of the present invention. The control module 40 functionally comprises a processor 60, wireless signal receiver 61, a plurality of temperature sensors, and a plurality of motor and heat element drivers. The sensors and drivers are attached to the processor 60 for coordinating operations. The user uses a remote control device (not shown) capable of generating and transmitting a control signal to the control module 40. The processor 60 of the control module 40 receives the signal through receiver 61, and interprets the command. The processor 60 coordinates operation based on the command received from the user, data gathered through the sensors, and executable instructions programmed in order to drive the appropriate drivers. The executable instructions may reside inside the processor 60 or externally accessible by the processor 60.

A roof top swiping panel driver 100 is to drive the motor 81 to cause the swiping panel 70 to operate. A left motor driver 101, and right motor driver 102 are to drive L motor 41 and R motor 42 for extending and retracting the cover 30. A hatch door relay 1 driver 103, hatch door relay 2 driver 104, hatch door relay 3 driver 105 and hatch door relay 4 driver 106 are there to drive relays for manipulating the corresponding hatch doors 36. Sensing switches 38 are to sense whether the hatch doors 36 in proper closing position. The processor 60 senses through the sensing switches 38 and coordinates the hatch door relay drivers 103, 104, 105 and 106 to ensure each of the hatch doors 36 are properly closed. Panel switch 1 relay driver 107 and panel switch 2 relay driver 108 drives the panel switch 79 and the panel switch 80, respectively, to lock and unlock the swiping panel 70 on top of the housing 20. There are a couple of temperature sensors attached to the processor 60. The temperature sensor 62 is to monitor the temperature around the control module 40. Heat element may be installed below the control module 40 to ensure operability of moving/operating parts and devices inside the control module 40. The other temperature sensor, temperature sensor 63 is to monitor the temperature around the roof top of the housing 20. The heat element, 76 may be installed beneath the roof of the housing 20 to melt layer of ice accumulated on the roof for the swiping panel 70 to operate properly. The wireless signal communication may be done through radio signal, or optical signal such as infrared. The user operates a wireless remote control means to transmit operational control signal to operate the apparatus. The transmitter of the remote control shall encode operational commands in such a way so that the processor 60 will not be operated mistakenly by receiving noise or by receiving signal from the wrong remote control means.

The processor 60 controls the heat element 76 for roof top of the housing 20 (not shown) by driving a heat element drive 110. The processor 60 also controls the heat element 86 for the control module 40 by driving a heat element drive 109.

It is to be understood that the embodiments and variations shown and described herein are merely illustrations of the principles of this invention and that various modifications may be implemented by those skilled in the art without departing from the spirit and scope of the invention.

What is claimed is:

1. An apparatus for remotely controlling a vehicle cover comprising:
(i) a cover for covering a vehicle;
(ii) a plurality of wires for guiding said cover to extend and retract from and to a housing mounted on said vehicle, wherein said cover is demountably and slidably attached to said wire;
(iii) a plurality of reel tables mounted on said vehicle to route and secure said wires and said cover; and
(iv) a control module comprising:
at least one motor for extending and retracting said covers by controlling said wires;
a means for receiving control signals remotely and wirelessly from a user operated remote control means; and
a means for interpreting and implementing said signals.

2. The apparatus as recited in claim 1, wherein said wireless control signals are transmitted through radio transmission.

3. The apparatus as recited in claim 1, wherein said wireless control signals are transmitted through optical transmission.

4. The apparatus as recited in claim 3, wherein said optical signal is infrared.

5. The apparatus as recited in claim 1, wherein said wires are transparent in color.

6. The apparatus as recited in claim 1 further comprises a housing enclosure to cover and protect said control module and said covers while retracted.

7. The apparatus as recited in claim 6, wherein said housing enclosure further comprises a means for sealing openings of said housing for said cover to extend and retract.

8. The apparatus as recited in claim 7, wherein said means for sealing openings of said housing is a hatch door.

9. The apparatus as recited in claim 7, wherein said means for sealing openings of said housing is a flexible and elastic cover.

10. The apparatus as recited in claim 7, wherein said means for sealing openings of said housing is a sliding door, wherein said sliding door slides inside said housing.

11. The apparatus as recited in claim 8, wherein said hatch door is operated automatically by said control module, wherein said control module operates a conventional means for opening and closing of said hatch door.

12. The apparatus as recited in claim 11, wherein said conventional means for opening and closing of said hatch door is a relay.

13. The apparatus as recited in claim 11 further comprises a sensing switch connected to said control module for sensing whether said hatch door is properly closed.

14. The apparatus as recited in claim 6, wherein said housing enclosure further comprises a heating element manipulated by said control module.

15. The apparatus as recited in claim 1 further comprises a means for swiping the roof top, wherein said means for swiping the roof top comprising:
(i) a motor;
(ii) a gear table to control panel movement;
(iii) at least two rails; and
(iv) a swiping panel for swiping said roof top by traveling along said rails,
wherein said swiping panel comprising:
a plurality of L shaped hooks to secure said swiping panel operablly attached to said rails; and
a plurality of gear table rollers operable by said motor for both positioning and movement of said swiping panel.

16. The apparatus as recited in claim 15, wherein said motor and said gear table are controlled by said control module.

17. The apparatus as recited in claim 15, wherein said swiping panel further comprises a brush at the contact with the roof top for sweeping.
